(19) United States
(12) Patent Application Publication
(10) Pub. No.: US 2010/0188573 A1
(43) Pub. Date: Jul. 29, 2010

(54) MEDIA METADATA TRANSPORTATION

(76) Inventors: Usva Kuusiholma, Helsinki (FI); Tuomas Sakari Tamminen, Espoo (FI)

Correspondence Address: SALTAMAR INNOVATIONS, 1 Mathewson Road, Barrington, RI, 02806, US

(21) Appl. No.: 12/361,543

(22) Filed: Jan. 29, 2009

(51) Int. Cl. H04N 7/025

(52) U.S. Cl. 348/468; 348/E07.017

(57) ABSTRACT

Media metadata is transported within closed caption data associated with the media intended to be presented as a sequence of media frames. A tag is associated with interactive content and the tag is inserted into the closed caption data. The tag is concealed from displaying by using destructive characters. On presenting the media, the closed caption data associated with the media is decoded and the tag is detected in the closed caption data. The destructive characters prevent the tag from being displayed for any discernable period of time.

### FIELD OF THE INVENTION

The present invention relates generally to media metadata transportation. The invention relates particularly, though not exclusively, to metadata transportation within closed caption data of media content.

### BACKGROUND OF THE INVENTION

Radio and television (TV hereinafter) have provided information and entertainment to their audience over decades. However, there has been no built-in feedback mechanism. For example, different TV or radio contests have had to collect the feedback through other channels, e.g. by providing dedicated phone numbers for different alternatives and inviting audience to call to the number related to a preferred choice. In other words, there has been little or no interaction.

One method for encoding interactive TV links and triggers is specified in an Electronic Industries Association (EIA) specification number 746 (EIA-746). US2002049843A1 discloses the use of the EIA-746 for the purpose of conveying URLs to Interactive TV terminals. This publication relates to a distributed system with plural server nodes that are continually updated such that each node is capable of handling any incoming request from any user.

Digital TV (DTV) was designed to provide interaction by means of a reverse channel (modem and public switched telephone network, PSTN) and a software platform that enables DTV receivers to run short applications which take care of interaction at a user based on information multiplexed along with a TV broadcast and of sending back over the PSTN line user's input. However, the bidirectional channel never became a success. This was largely due to two factors. First, the interactive programs required changes into many different elements starting from the TV program production, distribution, broadcasting and decoding. Second, the Internet became vastly familiar and provided a cheaper, more flexible and globally accessible channel for interactive media. The internet is genuinely bidirectional—or, more accurately, the Internet enables communication between any parties. Hence, a content provider may place content on her web page and reserve some place for interactive advertising content that is linked to an advertiser's own server. The advertiser can simply deliver the content for fitting into the advertiser's slot as hypertext markup language (HTML) code which the content provider can simply embed into her own web page HTML code. The content provider can use any web authoring tools and the interaction with an advertiser goes past the content provider. Hence, it is very simple to provide interactive content in the Internet.

Aside from the digital TV, there have been some attempts to provide interaction over TV by designing new standards or proprietary mechanisms for multiplexing new channels into TV broadcast. Such mechanisms do, however, inherently require changes into various entities including program recording, broadcasting and receiving. This results in an excessive economic threshold. For instance, in WO02/19309A1 publication it has been suggested to alter the standards for closed caption data of a TV broadcast so that closed captions would convey URLs (uniform resource locator) to a receiver so as to provide related content over the internet. See e.g. page 4, lines 16 to 17: interactive TV not subject to standardized requirements, and page 5, lines 13 to 19. However, then the produced program should contain links to the interactive content. Moreover, the URLs might appear on the TV display, or the programs should be customized to their recipients.

WO01/22729A1 discloses a system in which particular tags are inserted to facilitate control of digital video recording. Numerous different uses for tags are disclosed. The tags appear in an analogue stream within an Extended Data Services (EDS) field, implicitly using a closed caption field, modulated onto the vertical blanking interval (VBI), perhaps using the Advanced Television Enhancement Forum (ATVEF) specification, or time based (page 26). In a digital TV stream, or after conversion to MPEG from analog: in-band, using TiVo Tagging Technology, MPEG2 Private data channel, MPEG2 stream features (frame boundaries, etc.), Time-based tags. Virtually, this publication discloses that the tags could travel anywhere. The WO01/22729 discloses how the tags are encoded when sent with a TiVo Tag. Letters Tt followed by a single character indicate the length of the tag, followed by the tag contents, followed by a CRC for the tag contents. Such a combination is held sufficiently rare so that it can be almost guaranteed that this combination is a TiVo tag. However, there is no discussion on how the use of such tags would affect ordinary TV receivers. It appears that ordinary TV sets would simply show the tag as closed caption text on the screen and obstruct the display with a string that makes no sense to the user watching on the TV. Hence, this system appears to be useful only if one party can control each of the recording of media, delivery and playback.

### SUMMARY

According to a first exemplary aspect of the invention there is provided a method for media metadata transportation, wherein the media is intended to be presented as a sequence of media frames associated with closed caption data, the method comprising:
associating a tag with a pointer to interactive content;
inserting the tag into the closed caption data;
providing destructive characters in the closed caption data, for concealing the tag from displaying.

Advantageously, closed caption standard may be applied to inserting the tag such that closed caption standard compliant receivers will not display the tag.

The destructive characters may refer to backspace characters.

The destructive characters may refer to delete characters.

The destructive characters may refer to carriage return characters.

The method may further comprise computing an error detection code and encoding the error detection code into an error detection character that is inserted into the closed caption data together with the tag.

The tag may be recognized and differentiated from common closed caption data by detecting concealment of characters in the closed caption data.

The detection may further comprise checking whether the closed caption comprises an error detection character corresponding to concealed characters in the closed caption data.

The detection may further comprise identifying a predetermined series of visible characters and destructive characters in the closed caption data.

The predetermined series may comprise alternating back space or delete characters and visible characters.

Advantageously, no start and end tags are required if the tag is recognized based on an error detection character computed based on the concealed characters or based on unusual correction of caption data.

The error detection character may be located adjacent to the tag. Alternatively, the error detection character may be located at a predetermined location relative to the location of the tag within the closed caption data or relative to the closed caption data.

The error detection character may be concealed from displaying. The concealment may be performed by a destructive character in the closed caption data.

The closed caption data of one media frame may comprise visible closed caption data before the tag, after the tag, or both before and after the tag.

If visible closed caption data resides on one row only after the tag, the tag may be concealed by inserting a carriage return character after the tag such that the visible closed caption data will overwrite the tag.

Digital TV, analogue TV, Digital Versatile Disc (DVD) movies, RDS radio, cable TV, and various other media distribution schemes provide for textual information display to a user. In case of TV, there are standards such as EIA-608 and EIA-708 for the mechanism with which the closed caption data is relayed to a receiver.

According to a second aspect of the invention there is provided a method for media presentation for presentation of the media as a sequence of media frames associated with closed caption data, the method comprising:
decoding closed caption data associated with the media; and
detecting in the closed caption data a tag with a pointer to interactive content, the tag being concealed from displaying by destructive characters.

The tag may be recognized from the closed caption data by detecting concealing of characters in the closed caption data.

The detection of the tag may further comprise checking whether the closed caption comprises an error detection character corresponding to concealed characters in the closed caption data.

The error detection character may be concealed from displaying.

The concealment may be performed by a destructive character in the closed caption data.

The error detection character may be located adjacent to the tag.

The detection of the tag may further comprise identifying a predetermined series of visible characters and destructive characters in the closed caption data.

The predetermined series may comprise alternating back space or delete characters and visible characters.

According to a third aspect of the invention there is provided an apparatus for media metadata transportation, for presentation of the media as a sequence of media frames associated with closed caption data, the apparatus comprising:
a memory configured to store the media frames and the closed caption data; and
a processor configured by manipulate the memory to:
   associate a tag with a pointer to interactive content;
   insert the tag into the closed caption data; and
   providing destructive characters in the closed caption data, for concealing the tag from displaying.

According to a fourth aspect of the invention there is provided an apparatus for media presentation, for presentation of the media as a sequence of media frames associated with closed caption data, the apparatus comprising:
a memory configured to store the media frames and the closed caption data; and
a processor configured to manipulate the memory to:
   decode closed caption data associated with the media; and
   detect in the closed caption data a tag with a pointer to interactive content, the tag being concealed from displaying by destructive characters.

According to a fifth aspect of the invention there is provided a computer program embodied in a computer readable memory medium, which when executed on a computer enables the computer to perform media metadata transportation, for presentation of the media as a sequence of media frames associated with closed caption data, the computer program further comprising computer executable program code configured to enable the computer to:
associate a tag with a pointer to interactive content;
insert the tag into the closed caption data; and
provide destructive characters in the closed caption data, for concealing the tag from displaying.

According to a sixth aspect of the invention there is provided a computer program embodied in a computer readable memory medium, which when executed on a computer enables the computer to perform media presentation, for presentation of the media as a sequence of media frames associated with closed caption data, the computer program further comprising computer executable program code configured to enable the computer to:
decode closed caption data associated with the media; and
detect in the closed caption data a tag with a pointer to interactive content, the tag being concealed from displaying by destructive characters.

The decoding computer may be embodied as a portion of a Set-top Box (STB) or embedded within a television receiver.

Any preceding apparatus may be a modular element of a computing device. The apparatus may be part of a multi-purpose device with other substantial functions.

Any foregoing memory medium may be a digital data storage such as a data disc or diskette, optical storage, magnetic storage, holographic storage, phase-change storage (PCM) or opto-magnetic storage. The memory medium may be formed into a device without other substantial functions than storing memory or it may be formed as part of a device with other functions, including but not limited to a memory of a computer, a chip set, and a sub assembly of an electronic device.

Different aspects and embodiments of the present invention have been illustrated in the foregoing. Some embodiments may be presented only with reference to certain aspects of the invention. It should be appreciated that corresponding embodiments may apply to other aspects as well.

### BRIEF DESCRIPTION OF THE DRAWINGS

The invention will be described, by way of a non-limiting example only, with reference to the accompanying drawings, in which:

FIG. 1 shows a schematic drawing of a system according to an embodiment of the invention;

FIG. 2 shows a block diagram of a terminal according to an embodiment of the invention;

FIG. 3 shows a block diagram of a media processor according to an embodiment of the invention; and

FIG. 4 shows main steps of searching tags in closed caption processing.

### DETAILED DESCRIPTION

The term ‘destructive characters’ should be construed to mean characters which will erase or prevent the display of previously displayed characters. By way of non-limiting example, backspace characters (ASCII 0x08), delete characters (ASCII 0x7F) and the like. It is noted that carriage returns, spaces, and the like may also serve as destructive characters in specific combinations that will be clear to the skilled in the art.

In the following description, like numbers denote like elements.

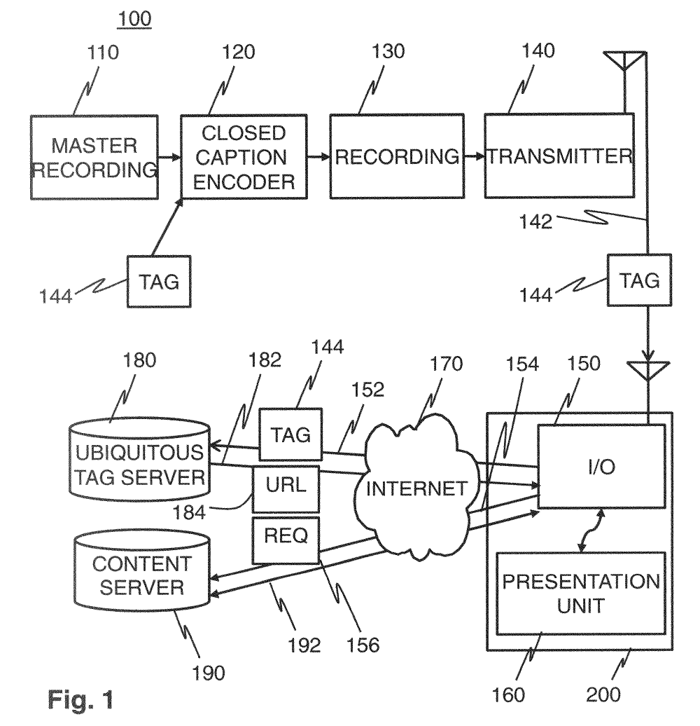

FIG. 1 shows a schematic drawing of a system 100 according to an embodiment of the invention. The system comprises a master recording unit 110 for recording media, a closed caption encoder 120 for inserting captioning to the media, the captioning including any normal captions and also a tag 144 when desired, a recording unit 130 for storing the captioned media, and a transmitter 140 for sending the captioned media with the tag 144 to a terminal 200. The terminal 200 comprises an input/output (I/O) unit 150 for receiving the captioned media and a presentation unit 160 for presenting the captioned media to the user. The I/O unit is further communicatively connected to a ubiquitous tag server 180 e.g. through the Internet 170. The tag server 180 is configured to provide addresses to interactive content corresponding to tags received from the terminal 200. One or more content servers 190 are provided to store different interactive contents associated with the addresses provided by the tag server 180.

In operation according to one embodiment, the transmitter 140 sends captioned media 142 with the tag 144 to the terminal 200. The terminal obtains the tag from the captioning and passes the tag through the Internet 170 to the tag server 180 with a tag signal 152 that is issued by a browser or corresponding application of the terminal 200. In response, the tag server 180 returns to the terminal 200 a uniform resource locator (URL) 184 corresponding to the tag in a URL signal 182 and redirects the application of the terminal 200 to the content server 190. The terminal 200 sends a request signal 154 with a request 156 to the URL 184. In response, the content server responds to the terminal 200 with interaction 192 that may involve a number of different signals in either direction between the terminal 200 and the content server 190. Responsive to the interaction 192, the terminal 200 obtains content to be presented to the user and presentation instructions concerning the manner in which the content should be presented. The terminal 200 then presents the content accordingly with the presentation unit. It is appreciated that the interaction may involve presenting prompts and/or reading user input and controlling the interaction based on the user input.

In general, existing equipment can be used to create the content for transmission. The tag 144 is inserted using ordinary captioning characters. The transmitter illustrates one common alternative for delivering the content. The transmitter 140 may be a television broadcast unit, either terrestrial, satellite or cable unit, a radio data service (RDS) radio transmitter capable of sending RDS text, an IP based unit, or even a peer-to-peer communication entity. Further alternatively, the content may be delivered by means of a content recording such as a digital versatile disc with audio/video content, a digital video tape, a digital radio recording or the like.

The preceding functional description of some examples illustrates already some advantages. For instance, pre-existing equipment is usable for preparing and delivering the media. A very small tag can be distributed to identify desired interaction so that no complicated multiplexing of new channels is needed, no bits need to be stolen from the media encoding, and ordinary captions can still be provided, and selectively displayed depending on user preferences (within the capabilities of the terminal 200). Non-compatible terminals will simply discard the tags without any harm to the user, as the tags are coded with suitable standardized characters to conceal the tag from captioning standard compliant terminals such that the tag will not be perceivable by a user i.e. the tag will not appear on the display for any discernable period of time. Moreover, the interaction associated to the media is freely adaptable by the content server until the interaction starts and even during the interaction. For instance, a DVD movie may be produced in Hollywood, USA. The movie is then sold in different states of the USA and also abroad. The movie comprises a trailer section with advertisements for other movies of the producer of the DVD. By obtaining the interaction data from the content server on displaying the movie, it is possible to adapt the content server for the interaction, to the appropriate language, culture, viewer's age, gender and socioeconomic position (if known), to insert commercial offerings based on local and national availability and regulations, and to insert any new material. By way of example, the user could be presented with an opportunity to order home delivery pizzas or taxi through proximate pizzeria just when the movie ends. Generally, any context sensitive interaction is possible since the user's own terminal interacts with the content server, which opens significant new opportunities. For instance, the content server may account for user's preferences, external conditions (weather, time of day, day of week, public holidays etc.), content providers own conditions (launch of new car model, or special offer for a model the stores of which have become excessively).

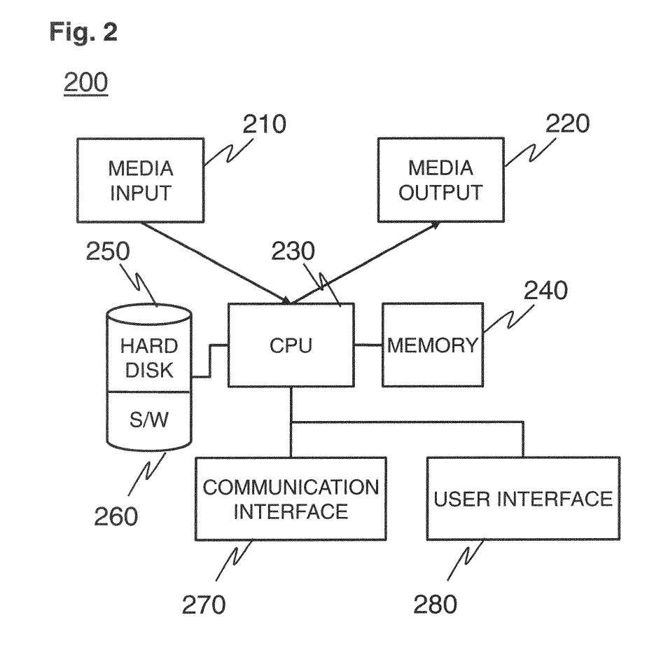

FIG. 2 shows a simplified block diagram of a terminal 200 capable of embodying different aspects of the invention. The terminal comprises a media input 210 for receiving at least one media stream (audio and/or video), and a media output 220 for passing processed media to a display device (not shown) such as a TV set, a liquid crystal display, a plasma display, a computer monitor, or a projector. The terminal 200 further comprises a processor 230 such as a central processing unit, a work memory 240 for short term storing of information such as buffers and registers needed by the processor 230, a non-volatile memory 250 such as a hard disk, read-only memory (ROM), compact disc (CD) or DVD. The non-volatile memory 250 comprises software 260 for controlling the operation of the processor. The software 260 typically comprises an operating system, different drivers and applications. The software 260 may further comprise one or more interpreters for interpreting computer instructions which are not compiled to natively usable code, but in this document generally computer executable refers to software that can be executed by a processor and that can thus control the operation of the processor. In effect, the software can thus control the operation of the equipment connected to the processor. Moreover, some elements of the terminal 200 may be capable of direct communication without instructions from the processor e.g. by using direct memory access or other data transfer mechanisms. The terminal further comprises a communication interface 270 such as a network interface or network adapter such as an Ethernet adapter. The terminal 200 typically comprises also other components such as a user interface (UI) 280, a power supply (not shown), redundant disk array(s), coolers, a main board, chipsets, basic input/output system and or the like.

The processor 230 may be a microprocessor, a digital signal processor, an application specific integrated circuit, a field programmable gate array, a microcontroller or a combination of such elements. It should be noted that in the case of application specific integrated circuit, the software 260 may be wholly or partially embedded therein, rather than exist on the non-volatile memory 250.

The media input 210 may be, for instance, a TV receiver, radio receiver, DVD-drive, or any other means for receiving media data, but it should be appreciated that this functional block may also or alternatively be incorporated into the communication interface. For instance, a cable TV may enable two-way communication over the communication interface, or the media data may be received over Internet Protocol (IP) packets or modem line through the communication interface 270.

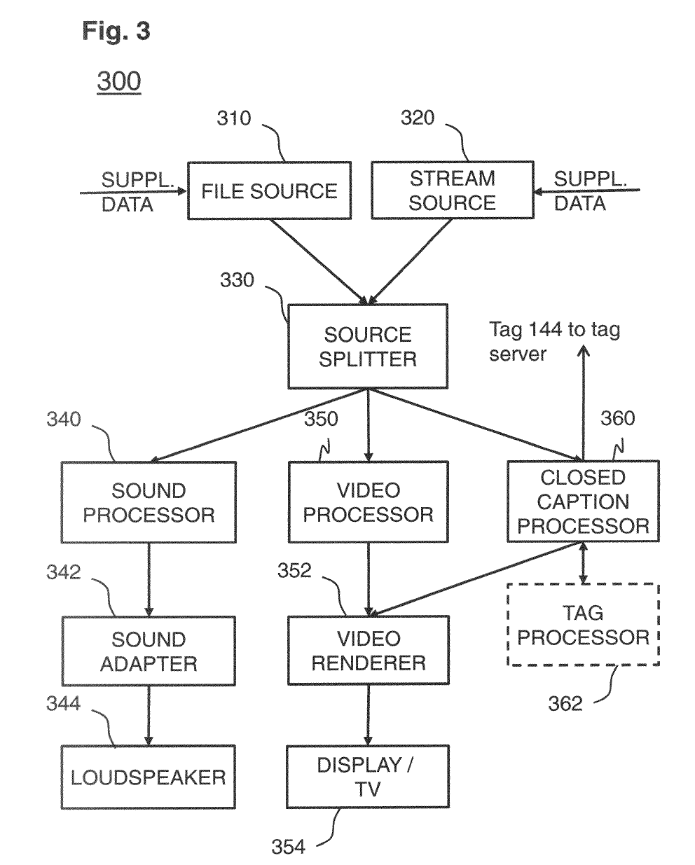

FIG. 3 shows a block diagram of a media processor 300 according to an embodiment of the invention. The media processor may be hardware based equipment, but typically it is a functionality that is at least partly provided by the processor 230 of the terminal 200 or in other words, software stored in the non-volatile memory 250. The media processor receives through the media input 210 off-line content from off-line sources (e.g. hard disc, DVD, memory card, memory stick) 310 and/or streaming content 320 (e.g. through analog or digital radio transmission, TV transmission, satellite transmission or data network transmission). Both the off-line content and the steaming content are commonly referred to as media content. The media content comprises media data (e.g. audio and video streams) with optional captions. Moreover, the streaming content source 320 receives supplementary content from the content server 190 for providing interactive data. The supplementary content typically comprises a presentation file such as a session description protocol (SDP) file or Synchronized Multimedia Integration Language (SMIL) file that defines how and when to present supplementary content and supplementary presentation information such as text, sound, a music definition file such as a MIDI-file, one or more still images, and/or one or more videos. It is appreciated that the off-line source 310 may also comprise some or all of the aforementioned supplementary content (in addition, or in alternative, to the streaming content source 320).

A source splitter 330 demultiplexes or divides out sound, video and closed caption data for respective sound processor 340, video processor 350 and closed caption processor 360. The sound processor 340 is followed by a sound adapter 342 that produces a sound signal for a subsequently connected loudspeaker 344. The sound processor further receives any supplementary content from the source splitter 330 if present. In one embodiment, the source splitter provides the sound processor 340 with only the audio part of the supplementary content, so as to avoid the sound processor from receiving any video content that could otherwise present an undue burden to the sound processor 340. If there is any supplementary audio content, the sound processor 340 overlays or substitutes the audio of the media content. The way the audio of the media content is handled during presentation of the supplementary content is dependent on implementation. For instance, the presentation information may define sound volume proportions for the supplementary audio and for the media data audio track(s), or the media processor may apply a factory setting, or the media processor may apply a setting made by the user.

The video processor 350 processes video signals, e.g. by decoding frames encoded in MPEG-2, MPEG-4, DIV-X, and like formats, into decoded video frames, and outputs the processed video signals to a video renderer 352. The closed caption processor 360 inputs close caption data and processes the closed caption data according to pertinent closed caption standards. The closed caption processor 360 further detects tags within the closed caption data stream and directs the tags to a separate tag processing within the closed caption processor 360 or with a dedicated tag processor 362. The closed caption processing produces captioning display information for display at particular regions of the display device. The captioning display information is also provided to the video renderer 352 for overlaying onto the image to be displayed. The video renderer outputs a display signal to a display device 354 such as a television, a monitor, and the like.

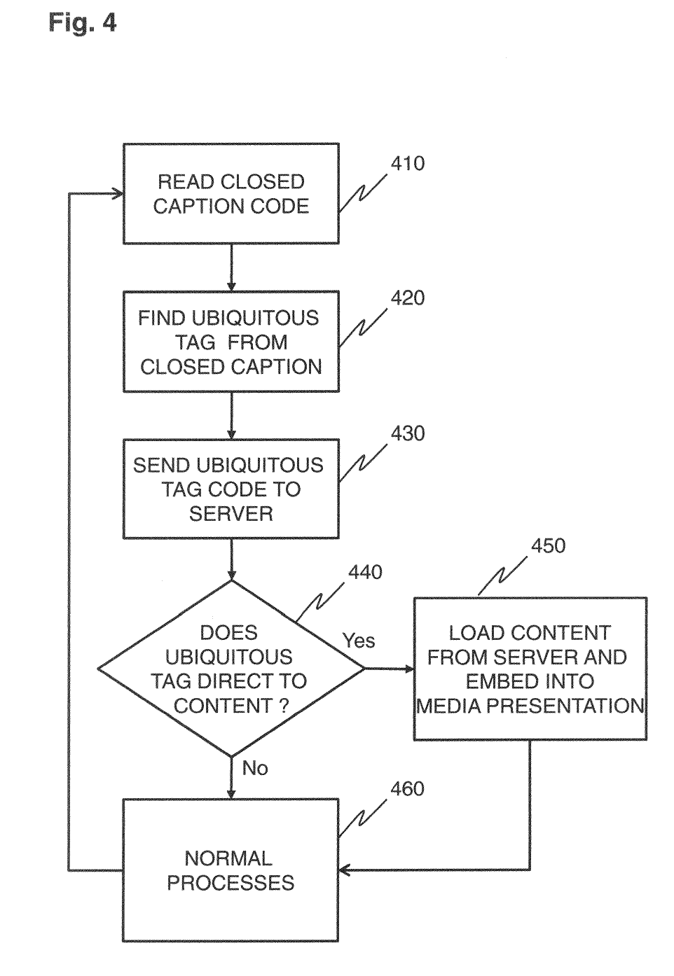

It is appreciated that the ordinary media processing related to sound, video and closed captions are well known, but additionally the closed captions are subjected to a tag search such as that disclosed in FIG. 4.

The video processing unit 350 may also receive supplementary data with video content and presentation information for overlaying or substituting the video of the media content.

Both the sound and video processing units make use of the timing provided by the presentation information such that they will correctly synchronize the output of the sound adapter and of the video render as desired. It is appreciated that the presentation of the media content may be buffered such that there should be sufficient time to retrieve the supplementary data after receiving the captioning within the media content based on the embedded tags 144. The sufficient time may be just a second or even less, especially if a session is pre-established with the content server 190 e.g. on starting up the terminal 200 or at the beginning of a given TV-program, radio program, or video.

FIG. 4 shows a simplified flow diagram presenting the main steps of searching tags in the closed caption processing 360. The process starts in step 410 in which the terminal 200 has received some caption data and the caption processing 360 is preparing captions according to normal captioning instructions. The closed caption code is read in this step 410. Then, a tag is searched 420 from the closed caption by testing whether the closed caption meets at least one criterion from the criteria listed below, for the presence of a tag:
There is a predetermined sequence of visible and destructive characters, e.g. characters and backspaces in a regularly alternating manner; and
There is a character that matches with an error detection code computed over preceding or subsequent characters.

It is appreciated that either of the preceding criteria enables detecting a tag without need to add any start, end, or length tokens into the closed caption data. Moreover, for the purpose of correlating a given interactive content to a particular position in a particular media stream, the tag can be very short. For instance, let us assume that upper and lower caps and numbers are used to present a tag. Hence, a set of 74 different ASCII characters are available. Let us further assume that the tag comprises two characters and one error detection character or checksum, so that three characters are needed to carry a tag and three backspace or delete characters are utilized to erase the tag from sight in those receivers which do not support the invention. The closed caption supports far longer captions, of course, but even with these six characters (three for tag and three for its erasing), we gain 2⁷⁴ i.e. roughly 18,9·10²¹ different tags. Should a larger base of tags be needed, more characters could be assigned to the tag.

Further, assuming a ten characters tag is desired and there were additionally some regular caption data for display on the screen. In this case, 12 characters would suffice for the tag instead of 22, because the tag and the error detection code could then be followed by a carriage return character and then by the normal caption text which would then be overwritten to conceal the tag and the error detection code.

Still further, longer tags can be concealed by placing a carriage return character in the middle of a tag and then as many back spaces as there were characters in the longer half of the tag (plus error detection code). E.g. a tag of 19 characters may take total of 19 characters+1 error detection+1 carriage return+10 back spaces=31 characters. Alternatively, if the 20 characters of tag and error detection code were divided into four character sequences, four carriage returns would be needed to leave one five character long sequence and five back spaces would delete from sight the remainder of tag with a total of 20+4+5=29 characters.

The error detection code can be, for instance, based on a modulo or integer division remainder. For instance, if there are 74 different characters ranging from ASCII 48 to 57 and from 65 onwards, all the characters would easily fit into a space of seven bits (128 alternatives). Each ASCII value of the tag could be summed up, e.g. for tag “A0”, the sum would be 65 plus 48=113 the modulo of which (by 128) is 113 and corresponds to ASCII character “q”. If the tag is placed in the front of the closed caption, it computationally simplifies the accumulation of a running sum of the ASCII values of the characters in the closed caption for comparison and verification of the tag content. If a match occurs, the presence of the tag can further be verified by determining whether any of the characters in the collected string would become visible if displayed by a normal closed caption compatible terminal and if none of the characters would be displayed, then a tag is practically certainly identified.

After the tag has been found, the tag is sent 430 (by the processor or more specifically by the closed caption processing function) to the tag server 180. It is then checked 440 if there is content corresponding to the tag i.e. whether the tag server recognizes the tag and has content associated therewith. If such content exists, the content is loaded 450 from the content server and embedded with the media e.g. by instructing the video and/or sound processing to reproduce such content. If not, normal processes related to the operation of the terminal 200 such as presenting media information are carried out in step 460 until closed caption data is received again and the operation resumes to step 410.

It is appreciated that the process identified in FIG. 4 is one process that may be carried out by the processor 230 or by other equipment of the terminal 200. Multitasking using common or separate hardware will allow other process to be concurrently executed.

The foregoing description has provided by way of non-limiting examples of particular implementations and embodiments of the invention a full and informative description of the best mode presently contemplated by the inventors for carrying out the invention. It will however be clear to a person skilled in the art that the invention is not restricted to details of the embodiments presented above, but that it can be implemented in other embodiments using equivalent means or in different combinations of embodiments without deviating from the characteristics of the invention. For instance, there may be more than one tags together in common closed caption data field, e.g. among closed caption data of a given frame or sequence of frames of media data, or one tag may be encoded using more than one closed caption data field. Moreover, various entities (e.g. the tag server 180, the content 190) may be implemented as an incorporated function within a common single entity or the functions of any singly described entity may be distributed on a number of different other entities. For instance, it may be advantageous to replicate a complete, or preferably, partial local copy of the tag server data and/or of the content server data to the terminal 200. Thus, the terminal 200 may be configured to pull any interactive content related to currently presented media or interactive data may be pushed in advance to a buffer or replicated copy of the tag server and/or of the content server. Such a pre-provisioning of a terminal with interactive content data may be particularly useful for popular live TV programs so that substantial peaks in load on the tag server 180 and on the content server 190 may be avoided or reduced. It is further noted that the function of detecting the tags may be performed by the same hardware and/or software which displays the close-caption data, or by a separate entity which filters the close-caption data prior to displaying.

Furthermore, some of the features of the above-disclosed embodiments of this invention may be used to advantage without the corresponding use of other features. As such, the foregoing description shall be considered as merely illustrative of the principles of the present invention, and not in limitation thereof.

We claim:

1. A method for media metadata transportation, for presentation of the media as a sequence of media frames associated with closed caption data, the method comprising:
associating a tag with a pointer to interactive content;
inserting the tag into the closed caption data; and
providing destructive characters in the closed caption data, for concealing the tag from displaying.

2. A method according to claim 1, wherein the destructive characters comprise backspace characters.

3. A method according to claim 1, wherein the destructive characters comprise delete characters.

4. A method according to claim 1, wherein the destructive characters comprise carriage return characters.

5. A method according to claim 1, wherein the method further comprises computing an error detection code and inserting the error detection character into the closed caption data together with the tag.

6. A method according to claim 5, wherein the error detection character is concealed from displaying.

7. A method according to claim 6, wherein the concealing is performed by a further destructive character in the closed caption data.

8. A method for media presentation, for presentation of the media as a sequence of media frames associated with closed caption data, the method comprising:
decoding closed caption data associated with the media; and
detecting in the closed caption data a tag associated with interactive content, the tag being concealed from displaying by destructive characters.

9. A method according to claim 8, wherein the destructive characters comprise backspace characters.

10. A method according to claim 8, wherein the destructive characters comprise delete characters.

11. A method according to claim 8, wherein the destructive characters comprise carriage return characters.

12. A method according to claim 8, wherein the tag is recognized from the closed caption data by detecting display-concealment thereof.

13. A method according to claim 8, wherein the detecting of the tag further comprises checking whether the closed caption comprises an error detection character corresponding to the tag or a portion thereof, in the closed caption data.

14. A method according to claim 13, wherein the error detection character is concealed from displaying.

15. A method according to claim 14, wherein the concealing is performed by at least one destructive character in the closed caption data.

16. A method according to claim 13, wherein the error detection character is located adjacent to the tag.

17. A method according to claim 8, wherein the detecting of the tag further comprises identifying a predetermined series of visible characters and destructive characters in the closed caption data.

18. A method according to claim 14, wherein the predetermined series comprises alternating back space or delete characters, and visible characters.

19. An apparatus for media metadata transportation, for presentation of the media as a sequence of media frames associated with closed caption data, the apparatus comprising:
a memory configured to store the media frames and the closed caption data; and
a processor configured to:
associate a tag with interactive content;
insert the tag into the closed caption data; and
insert destructive characters into the closed caption data for concealing the tag from displaying.

20. An apparatus according to claim 19, wherein the destructive characters comprise backspace characters.

21. An apparatus according to claim 19, wherein the destructive characters comprise delete characters.

22. An apparatus according to claim 19, wherein the destructive characters comprise carriage return characters.

23. An apparatus according to claim 19, wherein the processor is further configured to compute an error detection code and to insert the error detection character into the closed caption data together with the tag.

24. An apparatus according to claim 23, wherein the error detection character is concealed from displaying.

25. An apparatus according to claim 23, wherein the error detection character is concealed by including a further destructive character in the closed caption data.

26. An apparatus for media presentation, for presentation as a sequence of media frames associated with closed caption data, the apparatus comprising:
a memory configured to store the media frames and the closed caption data; and
a processor configured to:
decode closed caption data associated with the media; and
detect in the closed caption data a tag associated with interactive content, the tag being concealed from displaying by destructive characters.

27. An apparatus according to claim 26, wherein the destructive characters comprise backspace characters.

28. An apparatus according to claim 26, wherein the destructive characters comprise delete characters.

29. An apparatus according to claim 26, wherein the destructive characters comprise carriage return characters.

30. An apparatus according to claim 26, wherein the tag is recognized from the closed caption data by detecting concealing of characters in the closed caption data.

31. An apparatus according to claim 26, wherein the processor is configured to detect of the tag by checking whether the closed caption comprises an error detection character corresponding to concealed characters in the closed caption data.

32. An apparatus according to claim 31, wherein the error detection character is concealed from displaying.

33. An apparatus according to claim 32, wherein the error detection character is concealed by a further destructive character in the closed caption data.

34. An apparatus according to claim 32, wherein the error detection character is located adjacent to the tag.

35. An apparatus according to claim 26, wherein the processor is configured to detect of the tag by identifying a predetermined series of visible characters and destructive characters in the closed caption data.

36. An apparatus according to claim 35, wherein the predetermined series comprises alternating back space or delete characters, and visible characters.

37. A computer program embodied in a computer readable memory medium, which when executed on a computer enables the computer to perform media metadata transportation, for presentation of the media as a sequence of media frames associated with closed caption data, the computer program further comprising computer executable program code configured to enable the computer to:
associate a tag with interactive content;
insert the tag into the closed caption data; and
providing destructive characters in the closed caption data, for concealing the tag from displaying.

38. A computer program embodied in a computer readable memory medium, which when executed on a computer enables the computer to perform media presentation, for presentation of the media as a sequence of media frames associated with closed caption data, the computer program further comprising computer executable program code configured to enable the computer to:
decode closed caption data associated with the media; and
detect in the closed caption data a tag with a pointer to interactive content, the tag being concealed from displaying by destructive characters.
